(19) United States
(12) Patent Application Publication
(10) Pub. No.: US 2025/0310460 A1
(43) Pub. Date: Oct. 2, 2025

(54) STORAGE MEDIUM, CONTROL METHOD, AND INFORMATION PROCESSING APPARATUS FOR SETTING TRANSMISSION DESTINATION OF READ IMAGE

(71) Applicant: CANON KABUSHIKI KAISHA, Tokyo (JP)

(72) Inventor: TAKU SHINOHARA, Saitama (JP)

(21) Appl. No.: 19/088,260

(22) Filed: Mar. 24, 2025

(30) Foreign Application Priority Data
Mar. 26, 2024 (JP) 2024-049255

(51) Int. Cl. H04N 1/32; H04N 1/00

(52) U.S. Cl. CPC H04N 1/32096; H04N 1/0044

(57) ABSTRACT

A non-transitory computer-readable storage medium storing a program which is executed by a computer and is configured for supporting a software program that is commonly usable for a plurality of image processing apparatuses of respective manufacturers. The program causing the computer to execute: displaying, in a display, a setting reception screen through which setting of a transmission destination of a read image read by an image processing apparatus is received; and causing the image processing apparatus to transmit the read image to the transmission destination that has been received through the setting reception screen.

### BACKGROUND OF THE INVENTION

### Field of the Invention

The present invention relates to a storage medium, a control method, and an information processing apparatus.

### Description of the Related Art

There are known configurations in which a scanning apparatus (scanner) that reads, namely, scans an image is communicably connected to a host computer (information processing apparatus) that can process information in cooperation with the scanning apparatus. Further, the host computer gives a scan instruction to the scanning apparatus. In such cases, a scan driver, which is a control software used to control the scanning apparatus, for example, is installed in the host computer by the scanning apparatus. With this scan driver, the host computer can give the scan instruction to the scanning apparatus.

An operating system (referred to below as an “OS”) is preinstalled as basic software in the host computer. The scan driver is configured in conformity with specifications defined in the OS and can be activated in response to invoke from the OS. Such a scan driver is a model-specific scan driver, which depends on the vendor that supplies the scanning apparatus, namely, is suitable for the scanning apparatus that performs scanning.

Recently, Microsoft Windows (registered trademark) tends to provide a standard class driver (sometimes referred to below as “standard driver”) that are commonly usable for a plurality of scanning apparatuses, even if the scanning apparatuses are supplied by different vendors. Such standard drivers are prebuilt in the OS. By connecting any scanning apparatus to a host computer that has an OS containing a built-in standard driver, this scanning apparatus can perform scanning with the standard driver. This configuration can skip a process for installing the above model-specific scan driver.

Standard drivers are expected to have configurations in which it is possible to designate scanning functions of scanning apparatuses in accordance with scanning function information that has been generated based on information acquired from these scanning apparatuses. In short, with a single standard driver, a user who uses the standard driver can independently designate scanning functions of a plurality of scanning apparatuses in accordance with capabilities thereof.

Although the standard driver can be commonly used for a plurality of scanning apparatuses of different vendors, there may be a case in which some scanning apparatuses of predetermined vendors can not execute all functions thereof, for example. Japanese Laid-Open Patent Publication (kokai) No. 2021-033526 discloses a program for extending a print function of a print service which is generally usable with image forming apparatuses of different models or different vendors. With the extension, by operating a print setting screen adapted for an image forming apparatus of a model or vendor, a user can make the print forming apparatus to perform print functions that cannot be performed by the generally usable print service.

However, the standard driver does not support a setting of this transmission destination and cannot transmit a read image that has been read by an image processing apparatus, such as a scanning apparatus, to any transmission destination, even if a user wishes to do it. Thus, there is room for improvement.

### SUMMARY OF THE INVENTION

The present invention provides a mechanism for setting a transmission destination of a read image that has been read by an image processing apparatus, such as a scanning apparatus.

According to an aspect of the invention, the present invention provides a non-transitory computer-readable storage medium storing a program which is executed by a computer and is configured for supporting a software program that is commonly usable for a plurality of image processing apparatuses of respective manufacturers. The program causing the computer to execute: displaying, in a display, a setting reception screen through which setting of a transmission destination of a read image read by an image processing apparatus is received; and causing the image processing apparatus to transmit the read image to the transmission destination that has been received through the setting reception screen.

According to another aspect of the invention, a control method for controlling support of a software program that is commonly usable for a plurality of image processing apparatuses of respective manufacturers. The control method comprising: displaying, in a display, a setting reception screen through which setting of a transmission destination of a read image read by the image processing apparatus is received; and causing the image processing apparatus to transmit the read image to the transmission destination that has been received through the setting reception screen.

According to another aspect of the invention, an information processing apparatus that can be connected to a plurality of image processing apparatuses of respective manufacturers to enable communication and that can process information with each of the image processing apparatuses. The information processing apparatus comprising: a processor; and one or more memories storing a software program that is commonly usable for the image processing apparatuses of the respective manufacturers, and an application program supporting the software program. The application program, when executed by the processor, causes the information processing apparatus to: display, in a display, a setting reception screen through which setting of a transmission destination of a read image read by the image processing apparatus is received; and cause the image processing apparatus to transmit the read image to the transmission destination that has been received through the setting reception screen.

According to the present invention, when an image is read by an image processing apparatus such as a scanning apparatus, a transmission destination of the read image can be set.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a scanning system according to a first embodiment of the present invention.

FIGS. 2A and 2B are block diagrams each showing a software configuration of the scanning system.

FIGS. 3A to 3C are views each showing an example of a screen displayed in a display part of the scanning system.

FIG. 4 is a flowchart showing a process in which a scanning function extension unit edits scanning function information.

FIGS. 5A to 5C are views each showing an example of a list of scan information.

FIG. 6 is a sequence diagram showing a process to be performed between the scanning application, general-purpose scanning software, an extension application, and a scanning apparatus after a scanning application has received a scan setting.

FIG. 7 is a flowchart showing a process to be performed by the extension application.

FIG. 8 is a flowchart showing a process to be performed by the scanning apparatus.

FIG. 9 is a sequence diagram showing a process according to a second embodiment of the present invention to be performed between the scanning application, general-purpose scanning software, an extension application, and a scanning apparatus after a scanning application has received a scan setting.

FIG. 10 is a sequence diagram showing a variation in a process according to the second embodiment to be performed between the scanning application, general-purpose scanning software, an extension application, and a scanning apparatus after a scanning application has received a scan setting.

FIG. 11 is a sequence diagram showing a process according to a third embodiment of the present invention to be performed between the scanning application, general-purpose scanning software, an extension application, and a scanning apparatus after a scanning application has received scan setting.

FIG. 12 is a flowchart showing a process to be performed by the extension application.

FIG. 13 is a view showing an example of a screen displayed on a display part of a scanning system according to a fourth embodiment of the present invention.

FIG. 14 is a view showing an example of a screen displayed in a display part of a scanning system according to a fifth embodiment of the present invention.

FIGS. 15A and 15B are views each showing an example of a screen displayed in a display part of a scanning system according to a sixth embodiment of the present invention.

### DESCRIPTION OF THE EMBODIMENTS

The present invention will now be described in detail below with reference to the accompanying drawings showing embodiments thereof.

It should be noted that some configurations described in the following embodiments are merely examples. Thus, the scope of the present invention is not limited by the configurations described in the embodiments. For example, each of the components constituting the present invention can be replaced with any component that may exhibit a similar function. In addition, any other component may be added.

It is also possible to combine two or more configurations (features) from among the various embodiments.

### First Embodiment

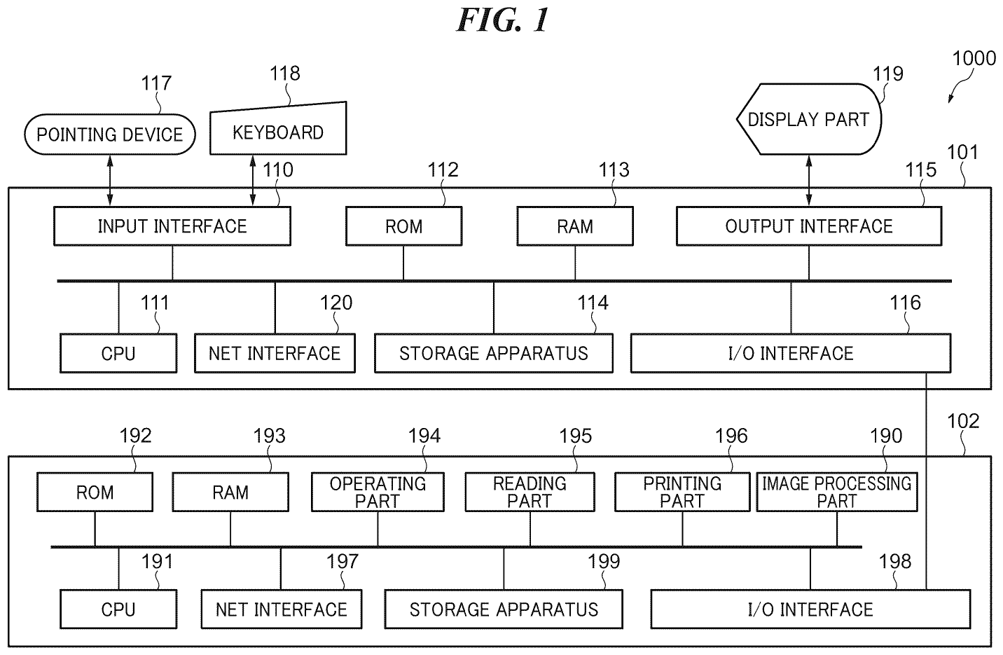

With reference to FIGS. 1 to 8, a first embodiment of the present invention will be described below.

FIG. 1 is a block diagram showing a hardware configuration of a scanning system 1000 according to the first embodiment. As shown in FIG. 1, the scanning system 1000 includes a host computer 101, a scanning apparatus (scanner) 102 as an example of an image processing apparatus, a pointing device 117, a keyboard 118, and a display part 119, all of which are communicably interconnected.

The host computer 101, which is an information processing apparatus, includes an input interface 110, a central processing unit (CPU) 111, read only memory (ROM) 112, random access memory (RAM) 113, a storage apparatus (storage medium) 114, an output interface 115, an input/output (I/O) interface 116, and a NET interface 120. One example of the host computer 101 is a desktop personal computer; however, the host computer 101 is not limited to this example. Other examples include a notebook personal computer, a tablet terminal, and a smartphone.

The CPU 111 is a computer that executes programs, for example, stored in the ROM 112 and the storage apparatus 114, thereby controlling various units and components in the scanning system 1000. In the present embodiment, the CPU 111 can perform processes in accordance with codes of programs stored in the ROM 112, thereby performing functions and processes of the host computer 101.

The ROM 112 stores an initialization program. The storage apparatus 114 stores a group of application programs, an operating system (OS), print data generation software, and other types of data. In the present embodiment, as the OS, Microsoft (registered trademark) Windows (registered trademark) 11 is built in the host computer 101. The storage apparatus 114 is not particularly limited; examples thereof include a hard disk drive (HDD) and a solid state drive (SSD). The RAM 113 is used as a work memory, for example, when various programs stored in the storage apparatus 114 are executed, so that various programs are activated in the host computer 101.

The input interface 110 is connected to the pointing device 117 and the keyboard 118, both of which serve as input devices. The output interface 115 is connected to the display part 119, which serves as a display device. The display part 119 displays, for example, a scan setting screen 300A or a detailed setting screen 300C, which will be described later. The NET interface 120 is a network interface, which controls data transfer with external apparatuses via a network.

The I/O interface 116 is connected to the scanning apparatus 102. This configuration enables the host computer 101 to communicate with the connected scanning apparatus 102, regardless of the manufacturer of the scanning apparatus 102. Since the I/O interface 116 is connectable to a plurality of scanning apparatuses, the host computer 101 can communicate with a plurality of scanning apparatuses of different manufacturers, namely, can process information between a plurality of scanning apparatuses of different manufacturers. The host computer 101 may be connected to the scanning apparatus 102 in either a wired or wireless fashion.

The scanning apparatus 102 includes an image processing part 190, a CPU 191, ROM 192, RAM 193, an operating part 194, a reading part 195, a printing part 196, a NET interface 197, an I/O interface 198, and a storage apparatus 199.

The CPU 191 is a computer that executes programs, for example, stored in the ROM 192 and the storage apparatus 199 and controls the scanning apparatus 102 in a centralized manner. The ROM 192 is a memory that stores programs. The RAM 193 is a memory that temporarily stores programs and image data.

The operating part 194 can give various operation instructions to the scanning apparatus 102. The reading part 195 reads an image of a document. Based on image data generated by reading an image of a document with the reading part 195, for example, the printing part 196 prints the image on a sheet. It should be noted that the printing part 196 may be omitted. The NET interface 197 is a network interface, which controls data transfer with external apparatuses via a network. The I/O interface 198 is connected to the host computer 101. For example, image data generated by reading an image of a document with the reading part 195 is input to the image processing part 190. Then, the image processing part 190 executes various types of editing processes to the image data.

The scanning apparatus 102 may be any image processing apparatus having an image reading function, namely, a scanning function; one example thereof is a multi-function peripheral (MFP). When an MFP is used as the scanning apparatus 102, a print operation performed by the MFP is an electrophotographic print operation in the present embodiment; however, the print operation is not limited thereto. For example, the print operation may also be an inkjet print operation. In the present embodiment, the host computer 101 and the scanning apparatus 102 are implemented as separate devices; however, the host computer 101 and the scanning apparatus 102 are not limited thereto. For example, the host computer 101 and the scanning apparatus 102 may be implemented as a single apparatus.

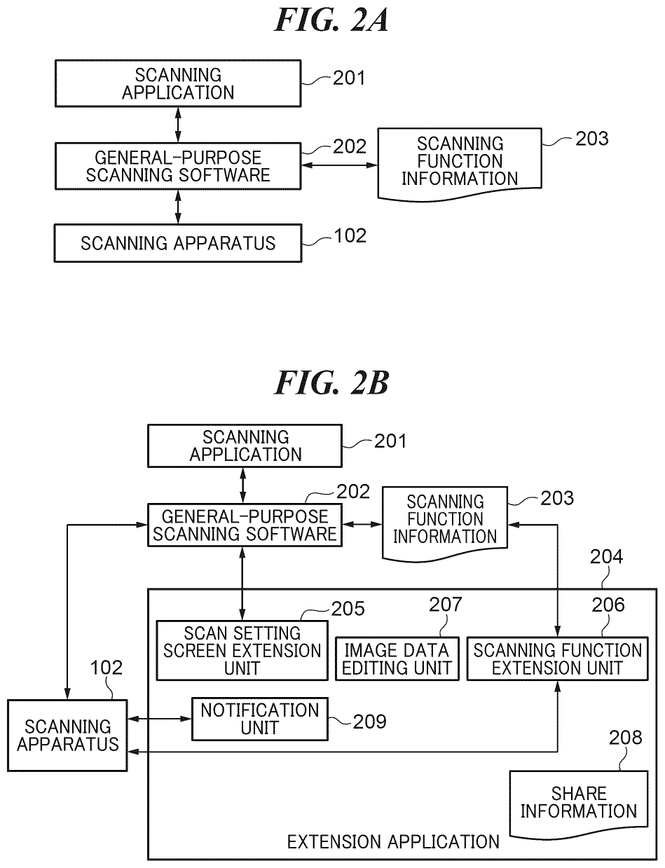

FIGS. 2A and 2B are block diagrams each showing a software configuration of the scanning system 1000. FIG. 2A is a diagram showing a general software configuration of the scanning system 1000 in a case where an extension application (application program) 204 is not associated with both general-purpose scanning software (software program) 202 and the scanning apparatus 102. FIG. 2B is a diagram showing a software configuration of the scanning system 1000 in a case where the extension application 204 is associated with both the general-purpose scanning software 202 and the scanning apparatus 102.

The general-purpose scanning software 202 is a general-purpose program that is commonly usable for a plurality of scanning apparatuses of different manufacturers, for example, during a scanning (image reading) operation. The general-purpose scanning software 202 is provided by a provider of the OS and prebuilt in the OS.

The extension application 204 is a program for supporting, namely, assisting the general-purpose scanning software 202. In the present embodiment, the extension application 204 is an extended program that provides, as extended functions, functions that cannot be performed by the general-purpose scanning software 202 for the scanning apparatus 102; however, the extension application 204 is not limited thereto. Alternatively, for example, the extension application 204 may be a program that improves convenience of functions that can be performed by the general-purpose scanning software 202 for the scanning apparatus 102. The extension application 204 is stored in the storage apparatus 114 together with, for example, the OS (general-purpose scanning software 202). As a result, the host computer 101 has both the general-purpose scanning software 202 and the extension application 204, which are stored in one or more storage media.

With reference to FIG. 2A, a description will be given of the software configuration of the scanning system 1000 in the case where the extension application 204 is not associated with both the general-purpose scanning software 202 and the scanning apparatus 102.

A scanning application 201 is software that captures a content (image data) that has been generated as a result of the scanning operation performed by the scanning apparatus 102. The scanning application 201 is not particularly limited; examples thereof include a document creation application and an image editing application.

The scanning application 201 issues a scan instruction to the OS, for example, in response to reception of a scan request from the user. This scan instruction contains scan setting information for instructing operations of the general-purpose scanning software 202 and the scanning apparatus 102.

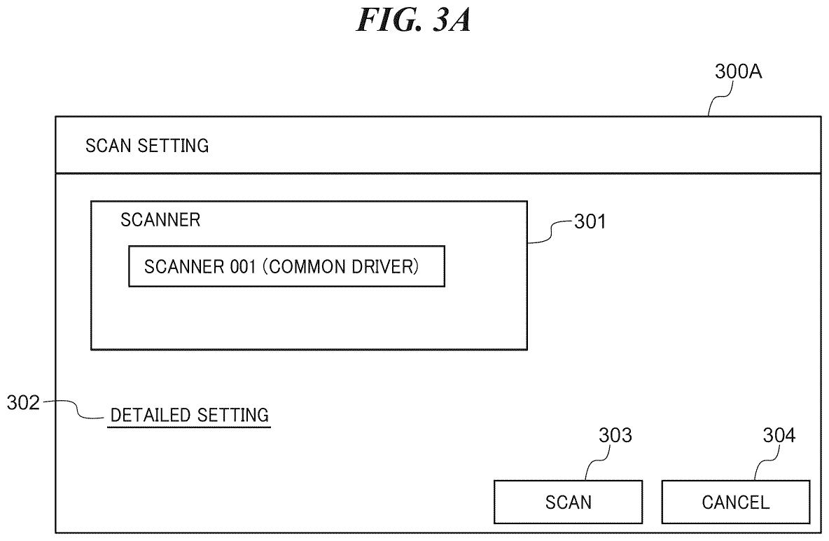

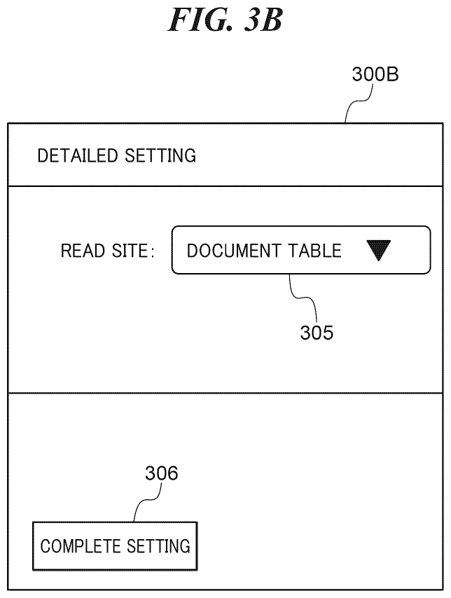

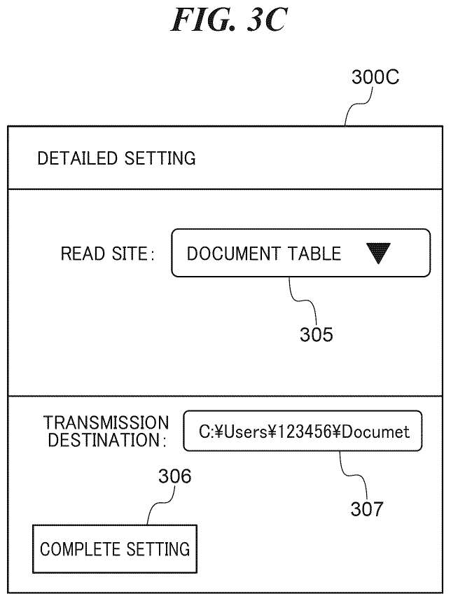

To issue the scan instruction, the scanning application 201 can display, in the display part 119, the scan setting screen 300A (see FIG. 3A) provided by any of the general-purpose scanning software 202, the OS, and the scanning application 201. In addition, the scanning application 201 can display a detailed setting screen 300B (see FIG. 3B) or the detailed setting screen 300C (see FIG. 3C) in the display part 119, in response to the operation (depression) of a control 302 on the scan setting screen 300A. Details of the scan setting screen 300A, the detailed setting screen 300B, and the detailed setting screen 300C will be described later.

The scan setting screen 300A contains a setting item indicating a settable scanning function and a control item indicating the setting value. Both the setting item and the control item are displayed in accordance with capability information acquired from the general-purpose scanning software 202, namely, in accordance with information settable as scan settings. The “capability information” refers to information regarding a capability of the scanning apparatus 102 to perform the scanning operation. It is also possible to determine whether this capability information contains information that enables the display of the detailed setting screen 300C. As a result of this determination, when the capability information is determined to contain the information that enables the display of the detailed setting screen 300C, the scanning application 201 can display the detailed setting screen 300C in the display part 119. When it is determined that the capability information is not determined to contain any information that enables the display of the detailed setting screen 300C, the scanning application 201 does not display the detailed setting screen 300C.

Scanning function information 203 is data showing scan functions in which all settable scanning functions, setting values thereof, exclusive relationships between the setting values, and others are described. The scanning function information 203 is contained in a configuration file of the general-purpose scanning software 202 and is deployed in the storage apparatus 114 as an unmodifiable file.

The scanning function information 203 is dynamically generated by the general-purpose scanning software 202. More specifically, the general-purpose scanning software 202 acquires attribute data on the scanning apparatus 102 from the scanning apparatus 102. The general-purpose scanning software 202 then generates the scanning function information 203, based on attribute information in the attribute data. If the scanning function information 203 is dynamically generated in this manner, the scanning function information 203 is editable. The attribute data on the scanning apparatus 102 contains attribute information indicating functions (capability of the scanning apparatus 102) that can be designated by the scanning apparatus 102 and a setting value related to this attribute information, which are stored in the RAM 113.

With such a configuration, the general-purpose scanning software 202 enables the user to designate scanning functions available in the scanning apparatus 102 connected to the host computer 101 which are specific to the scanning apparatus 102. With this scanning function information 203, the user can designate scanning functions available in the connected scanning apparatus 102, in regardless of the type of the scanning apparatus 102 connected to the host computer 101, namely, even when a scanning apparatus having different functions from those of the scanning apparatus 102 or a scanning apparatus developed by another scanner manufacturer is connected to the host computer 101.

It should be noted that in the present embodiment, the general-purpose scanning software 202 is expected to be a standard class driver that performs the scanning operation based on a standard scanning protocol called Mopria. More specifically, the general-purpose scanning software 202 is not a unique scan driver specific to the model of the scanning apparatus 102 but is a standard class driver that is commonly usable for scanning apparatuses 102 of different scanner manufacturers and is independent from the scanner manufacturers. Furthermore, the general-purpose scanning software 202 acquires the capability information on the scanning apparatus 102 and, based on this information, generates the scanning function information 203.

The general-purpose scanning software 202 can be associated with an extension application 204. This configuration can provide functions that are not supported by the general-purpose scanning software 202. For example, the general-purpose scanning software 202 is not configured to receive a setting of a transmission destination of a scanned image (read image) that has been read by the scanning apparatus 102. In other words, the general-purpose scanning software 202 fails to support the setting of the transmission destination. This is because the setting of the transmission destination is an original function to be performed by the scanning apparatus 102 of a predetermined scanner manufacturer.

The extension application 204 can make the extension so as to enable the setting of the transmission destination which cannot be performed by the general-purpose scanning software 202. In the present embodiment, the general-purpose scanning software 202 does not support the setting of the transmission destination, but the extension application 204 enables the setting of the transmission destination as an extension function; however, the present invention is not limited to this configuration. Alternatively, the general-purpose scanning software 202 can perform a portion of setting of the transmission destination, and the extension application 204 may compensate for the lack of the setting of the transmission destination, thereby further extending the functions that can be performed by the extension application 204.

With reference to FIG. 2B, a description will be given of a software configuration of the scanning system 1000 in a case where the extension application 204 is associated with both the general-purpose scanning software 202 and the scanning apparatus 102. FIG. 2B differs from FIG. 2A in that the extension application 204 is added to the software configuration of the scanning system 1000. In this configuration, the host computer 101 includes the extension application 204 in addition to the scanning application 201, the general-purpose scanning software 202, and the scanning function information 203.

The extension application 204 is software for extending the functions of the general-purpose scanning software 202 and is sometimes simply referred to as the “scanning software”. It should be noted that the extension application 204 is software that is not contained (built) in the OS in advance. Thus, in response to a user's operation on the host computer 101, the extension application 204 is downloaded from a server (not shown) via the Internet, thereby being installed in the host computer 101.

Alternatively, when the scanning apparatus 102 becomes connected to the host computer 101, the extension application 204 may be automatically installed in the host computer 101 based on this connection. More specifically, when the scanning apparatus 102 becomes connected to the host computer 101, the OS acquires device identification information from the scanning apparatus 102. The OS then may download the extension application 204 related to the device identification information from the server via the Internet and may install this extension application in the host computer 101. As a result, both the general-purpose scanning software 202 and the extension application 204 are retained in the host computer 101 as different control programs.

The general-purpose scanning software 202 and the extension application 204 may be individually updated and upgraded. In this case, the process of updating the general-purpose scanning software 202 and the process of updating the extension application 204 may be performed at the same timing or may be performed at different timings.

The trigger at which the host computer 101 acquires the general-purpose scanning software 202 and the trigger at which the host computer 101 acquires the extension application 204 may be a same trigger or may be separated triggers. In addition, when the extension application 204 is installed in the host computer 101, the OS associates the extension application 204 with both the general-purpose scanning software 202 and the scanning apparatus 102.

As illustrated in FIG. 2B, the extension application 204 can exchange (transmit/receive) information between each one of the general-purpose scanning software 202 and the scanning apparatus 102. In short, the extension application 204 is associated with both the general-purpose scanning software 202 and the scanning apparatus 102.

In the present embodiment, the extension application 204 includes a scan setting screen extension unit 205, a scanning function extension unit 206, an image data editing unit 207, and a notification unit 209. Moreover, the extension application 204 includes share information 208 which is accessible from each of the scan setting screen extension unit 205, the scanning function extension unit 206, the image data editing unit 207, and the notification unit 209. The share information 208 is a file stored in the storage apparatus 114 or information stored in the RAM 113. The extension application 204 can write and read the share information 208 by using an application program interface (API) provided by the OS.

The extension application 204 may terminate the overall operation of the extension application 204 in response to the completion of the process in each of the scan setting screen extension unit 205, the scanning function extension unit 206, the image data editing unit 207, and the notification unit 209. In this case, the OS needs to activate the extension application 204 at each time when the OS receives a process execution request for each unit.

The extension application 204 may cancel the process which is currently performed by each of the scan setting screen extension unit 205, the scanning function extension unit 206, the image data editing unit 207, and the notification unit 209. In this case, the OS deletes the scan job being processed. As described above, the scanning application 201 issues the scan instruction to the OS in response to the reception of the scan request from the user.

The scanning application 201 can display a scan setting screen in the display part 119. In the configuration shown in FIG. 2B, the scanning application 201 can display, in the display part 119, the scan setting screen 300A (and the detailed setting screen 300C as necessary) provided by the scan setting screen extension unit 205 (extension application 204). In addition, the scan setting screen extension unit 205 can save detailed settings that have been set by the user in the share information 208.

The image data editing unit 207 acquires image data from the scanning apparatus 102. After having acquired the image data, the image data editing unit 207 can edit the image data. Furthermore, the image data editing unit 207 acquires the detailed setting information from the share information 208 and, based on this detailed setting information, performs image editing on the image data. The extension application 204 may perform image editing on the image data acquired by the general-purpose scanning software 202, based on the detailed setting information. In the configuration in FIG. 2B, there are cases where the transmission destination does not have to be set. In such cases, the general-purpose scanning software 202 may transmit a scan request instruction to the scanning apparatus 102 without passing the scan request instruction through the extension application 204.

The scanning function extension unit 206 can edit the scanning function information 203 generated by the general-purpose scanning software 202 or the OS. The scanning function extension unit 206 thereby can add functions provided by the extension application 204. Furthermore, the scanning function extension unit 206 can add functions (e.g., a transmission destination setting function) that are supported by the scanning apparatus 102 but not supported by the general-purpose scanning software 202 and can also add an exclusive relationship between setting values of the scanning functions, for example.

Once the extension application 204 becomes associated with both the scanning apparatus 102 and the general-purpose scanning software 202, the OS activates the scanning function extension unit 206. Alternatively, the OS may activate the scanning function extension unit 206 at another timing (e.g., at the time of the activation of the OS). Even if functions related to the scanning operation are extended later in response to such activation, the scanning function extension unit 206 can detect extension functions and add these extension functions to the scanning function information 203.

The notification unit 209 can notify the occurrence of the error when an error occurs in the scanning apparatus 102. If a read-jam error occurs in the scanning apparatus 102, for example, the general-purpose scanning software 202 detects the occurrence of this error. In response, the OS performs a notification function, called a toast notification, which is one of the functions of the OS, thereby displaying, in the display part 119, a message about the occurrence of the read-jam error, which is a detection result of the general-purpose scanning software 202. In this case, in response to a user's operation on the toast notification, the OS calls the notification unit 209, thereby displaying, in the display part 119, a user interface screen (UI screen) of the notification unit 209. On this user interface screen, for example, a detailed message related to the read-jam error or a jam releasing method can be displayed.

In the foregoing present embodiment, the extension application 204 can be said to have the following four functions. A first function is a function of displaying a setting screen. This function is performed by the scan setting screen extension unit 205. A second function is a function of editing image data, based on the detailed setting information. This function is performed in the image data editing unit 207. A third function is a function of adding, as extension functions, functions that can be designated by the image data generation software. This function is performed by the scanning function extension unit 206. A fourth function is a function of displaying a screen in response to an occurrence of an error in the scanning apparatus 102. This function is performed in the notification unit 209.

It should be noted that the configuration of the extension application 204 is not limited to the configuration having these four functions; however, the configuration of the extension application 204 is preferably a configuration having at least one of the functions. Alternatively, the configuration of the extension application 204 may be a configuration having any other function.

FIGS. 3A to 3C are views each showing an example of a screen displayed in the display part 119 of the scanning system 1000. FIG. 3A shows the scan setting screen 300A displayed in the display part 119 by the scanning application 201. FIG. 3B shows the detailed setting screen 300B displayed in the display part 119 in the case where the extension application 204 is not configured to be associated with both the general-purpose scanning software 202 and the scanning apparatus 102. FIG. 3C shows the detailed setting screen 300C displayed in the display part 119 in the case where the extension application 204 is configured to be associated with both the general-purpose scanning software 202 and the scanning apparatus 102. It should be noted that a software unit and a module for displaying each screen are not particularly limited. For example, the scan setting screen extension unit 205 may be configured only to generate a display screen. In this case, the scan setting screen extension unit 205 may transmit the generated display screen to the scanning application 201 via the general-purpose scanning software 202. In response, the scanning application 201 may be configured to display the acquired display screen in a display apparatus, such as the display part 119.

The scan setting screen 300A shown in FIG. 3A is a screen through which information regarding the scanning operation to be performed by the scanning apparatus 102 can be set. The scan setting screen 300A contains a control (button) 301, the control 302, a control 303, and a control 304.

With the control 301, a scanner apparatus used to read a document can be selected and set. In FIG. 3A, as an example, a scanner apparatus used to read a document is set to “scanner 001 (common driver)”. With the control 302, details of the scan information can be set. With the control 303, the scanning apparatus 102 can be instructed to start performing the scanning operation. With the control 304, the scanning apparatus 102 can be instructed to cancel the scanning operation.

In the case where the extension application 204 is not associated with both the scanning apparatus 102 and the general-purpose scanning software 202, when the control 302 is operated, the detailed setting screen 300B is displayed as shown in FIG. 3B in the display part 119. The detailed setting screen 300B contains a control 305 and a control 306.

With the control 305, a read site at which a document is to be read in the scanning apparatus 102, namely, a placement site at which a document to be read is placed can be selected and set. In an example in FIG. 3B, for example, the scanning apparatus 102 has a document table (document table glass) and a feeder, and the “document table” is selected as the document read site. With the control 306, the setting with the control 305 can be completed. Furthermore, in response to the operation of the control 306, the screen is returned to the scan setting screen 300A shown in FIG. 3A.

In the case where the extension application 204 is configured to be associated with both the scanning apparatus 102 and the general-purpose scanning software 202, when the control 302 is operated, the detailed setting screen (setting reception screen) 300C is displayed as shown in FIG. 3C in the display part 119 (display control step). In this case, the detailed setting screen 300C is a screen displayed together with the scan setting screen 300A; however, a display mode thereof is not particularly limited. As an example, the detailed setting screen 300C may be displayed so as to overlap the scan setting screen 300A. As an alternative example, the detailed setting screen 300C may be displayed adjacent to the scan setting screen 300A. The detailed setting screen 300C may be displayed once after the scan setting screen 300A has disappeared.

The detailed setting screen 300C contains a control 305 and a control 306, similar to the detailed setting screen 300B. In addition, the detailed setting screen 300C contains a control 307. The control 307 is an input part that can be used to input a transmission destination of a scanned image that has been read by the scanning apparatus 102. In FIG. 3C, a file path “C: ¥User¥123456¥Document” is inputted to the control 307 as the transmission destination of the scanned image.

As described above, the detailed setting screen 300C is configured so as to enable setting of the transmission destination of the scanned image. And, by operating the control 306 after the transmission destination of the scanned image has been inputted to the control 307, the setting with the control 307 is determined, namely, the setting of the transmission destination of the scanned image is completed. As described above, in the detailed setting screen 300C, the control 306 functions as a determination operating part for the setting of the transmission destination to be completed and determined. When the setting of the transmission destination is completed and determined, it is possible to instruct the scanning apparatus 102 to transmit the scanned image to the transmission destination that has been inputted to the control 307 (transmission step).

A description will be given of the reason why the items contained in the detailed setting screen 300B shown in FIG. 3B are different from the items contained in the detailed setting screen 300C shown in FIG. 3C. In addition, a description will be given of the reason why it is possible to switch between the display of the detailed setting screen 300B and the display of the detailed setting screen 300C.

Each of the detailed setting screen 300B and the detailed setting screen 300C is generated based on the scanning function information (capability information). As described above, the general-purpose scanning software 202 does not support the setting of the transmission destination. Thus, using the general-purpose scanning software 202 alone cannot add the transmission destination setting function to the scanning function information. Even if the transmission destination setting function is originally contained in the scanning function information, the general-purpose scanning software 202 cannot interpret the transmission destination setting function contained in the scanning function information. As a result, it is impossible to display the transmission destination setting on the detailed setting screen. For this reason, the scanning function extension unit 206 adds the transmission destination setting function to the scanning function information 203. The scan setting screen extension unit 205 then displays the detailed setting screen 300C with reference to the capability information. The detailed setting screen 300C is a screen through which the transmission destination can be set. It should be noted that the detailed setting screen 300C may additionally contain some setting items other than the transmission destination setting.

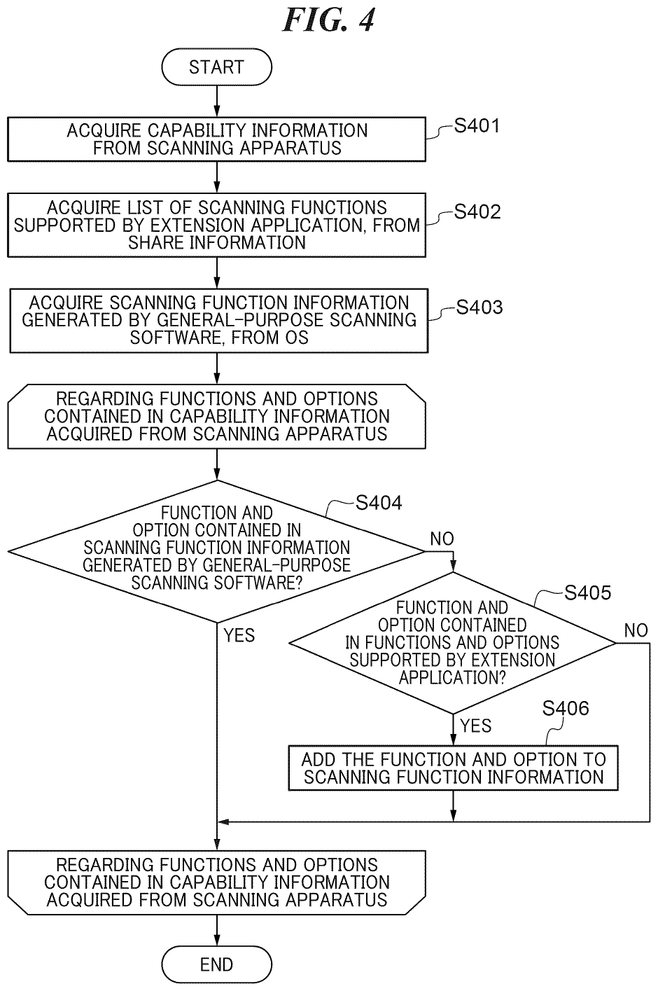

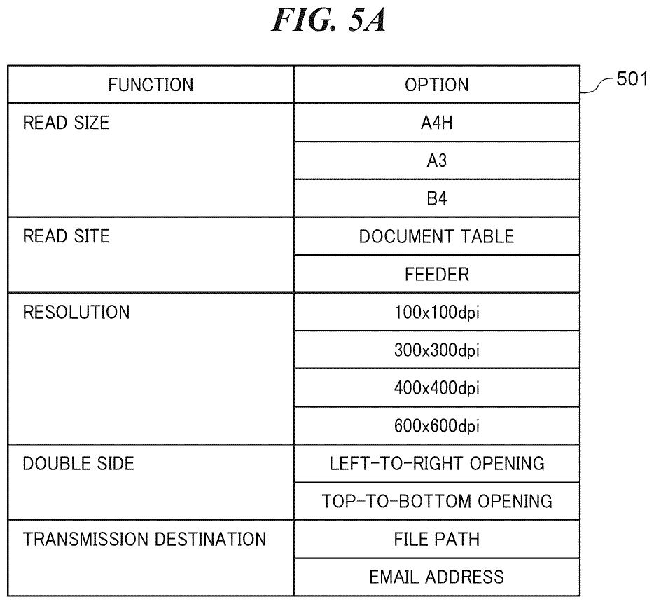

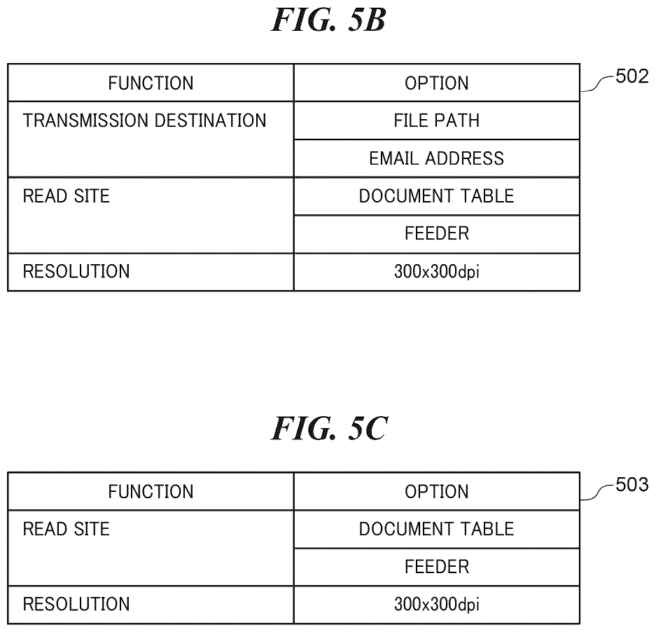

With reference to FIG. 4 and FIGS. 5A to 5C, a description will be given below of a process in which the scanning function extension unit 206 edits the scanning function information. FIG. 4 is a flowchart showing the process in which the scanning function extension unit 206 edits the scanning function information. The individual operations (steps) in the flowchart shown in FIG. 4 are realized by the CPU 111 reading the extension application 204 (scanning function extension unit 206) into the RAM 113 and performing it. In addition, some processes, such as data transmission and information input/output, are realized by the CPU 111 cooperating with various interfaces of the host computer 101. To clarify programs that serve as a main body that realizes each process shown in the flowchart, a software unit, such as the scanning function extension unit 206, an application, and so on will be described as subjects. FIGS. 5A to 5C are views each showing an example of a list of scan information.

In step S401, as shown in FIG. 4, the scanning function extension unit 206 acquires the capability information from the scanning apparatus 102. The capability information contains attribute information indicating functions that can be designated for the scanning apparatus 102 and setting values related to this attribute information.

Table 501 shown in FIG. 5A shows a list of capability information acquired from the scanning apparatus 102. As shown in Table 501, some functions, such as those of setting a read size, and options settable for each function can be acquired from the scanning apparatus 102. For example, the function of setting the transmission destination of a scanned image provides options “file path” or “Email address”.

In step S402, the scanning function extension unit 206 acquires the scanning functions supported by the extension application 204, from the share information 208. The share information 208 stores a list of scanning functions supported by the extension application 204.

Table 502 shown in FIG. 5B contains all the scanning functions that can be performed (supported) by the extension application 204 and some setting values thereof. For example, the function of setting the transmission destination of a scanned image provides options “file path” or “Email address”. In this case, the scanning functions that can be performed by the extension application 204 may be updated.

In step S403, the scanning function extension unit 206 acquires, from the OS, the scanning function information 203 created by the general-purpose scanning software 202. In this case, the scanning function information 203 is created based on the capability information that the general-purpose scanning software 202 has acquired from the scanning apparatus 102.

The scanning function information 203 created by the general-purpose scanning software 202 contains, of the scanning functions contained in the capability information acquired from the scanning apparatus 102, only some that can be performed by the general-purpose scanning software 202. Table 503 shown in FIG. 5C contains all the scanning functions that can be performed by the general-purpose scanning software 202 and some setting values thereof. As can be found from Table 503, the scanning functions performed by the general-purpose scanning software 202 do not include a function of setting the transmission destination of a scanned image. Thus, the scanning function information 203 does not contain the function of setting the transmission destination of a scanned image. The scanning function extension unit 206 adds some functions and options to the scanning function information 203, so that the extension application 204 can compensate for the lack of functionality of the general-purpose scanning software 202. In addition, the scanning function extension unit 206 can also delete unnecessary functions and options from the scanning function information 203 created by the general-purpose scanning software 202.

Steps S404, S405, and S406 are processes to be repeatedly performed on the functional list contained in the capability information that has been acquired from the scanning apparatus 102 in step S401. In the present embodiment, steps S404, S405, and S406 are repeatedly performed on 13 options contained in Table 501.

In step S404, the scanning function extension unit 206 determines whether a currently processed function and option is contained in the scanning function information 203 generated by the general-purpose scanning software 202. As a result of the determination in step S404, when it is determined that the currently processed function and option is contained in the scanning function information 203, if the last option item is being processed, the scanning function extension unit 206 terminates the process. If the currently processed function and option is not the last option item, the scanning function extension unit 206 selects the next option item and then performs step S404 again.

As a result of the determination in step S404, when it is determined that the function and option is not contained in the scanning function information 203, the process proceeds to step S405. In the present embodiment, for example, Table 501 contains “document table” as the read site, whereas Table 503 also contains “document table” as the read site. In this case, in step S404, the scanning function extension unit 206 determines that the currently processed function and option item is contained in the scanning function information 203. On the other hand, Table 501 contains “file path” and “Email address” as the option items of the transmission destination, whereas Table 503 does not contain “file path” and “Email address” as the option items of the transmission destination. In this case, in step S404, the scanning function extension unit 206 determines that currently processed functions and options are not contained in the scanning function information 203.

In step S405, the scanning function extension unit 206 determines whether the currently processed function (option) is contained in the functions (options) supported by the extension application 204. As a result of the determination in step S405, when the currently processed function is determined as being contained, the scanning function extension unit 206 proceeds process to step S406. As a result of the determination in step S405, when the currently processed function is determined as not being contained, the scanning function extension unit 206 terminates the process if the last option item is being processed, as in the case where “Yes” is selected in step S404. If the last option item is not being processed, the scanning function extension unit 206 selects the next option item and performs step S404 again. In the present embodiment, for example, when the currently processed function is the transmission destination “file path”, the transmission destination “file path” is also contained in Table 502. Thus, in step S405, it is determined that the currently processed function is contained.

In step S406, the scanning function extension unit 206 adds the currently processed function (option) to the scanning function information 203. After having performed step S406, the scanning function extension unit 206 terminates the process if the last option item is being processed, as in the case where the determination is “Yes” in step S404. If the last option item is not being processed, the scanning function extension unit 206 selects the next option item and performs step S404 again.

In the above way, the extension application 204 can add, to the scanning function information 203, functions (options) that are not supported by the general-purpose scanning software 202 but are supported by both the scanning apparatus 102 and the extension application 204. Based on the scanning function information 203 that has been edited by this adding process, the capability information is generated. Based on this capability information, the scan setting screen extension unit 205 generates a display screen, thereby successfully extending functions that are not supported by the general-purpose scanning software 202 and displaying the detailed setting screen 300C shown in FIG. 3C in a display apparatus, such as the display part 119.

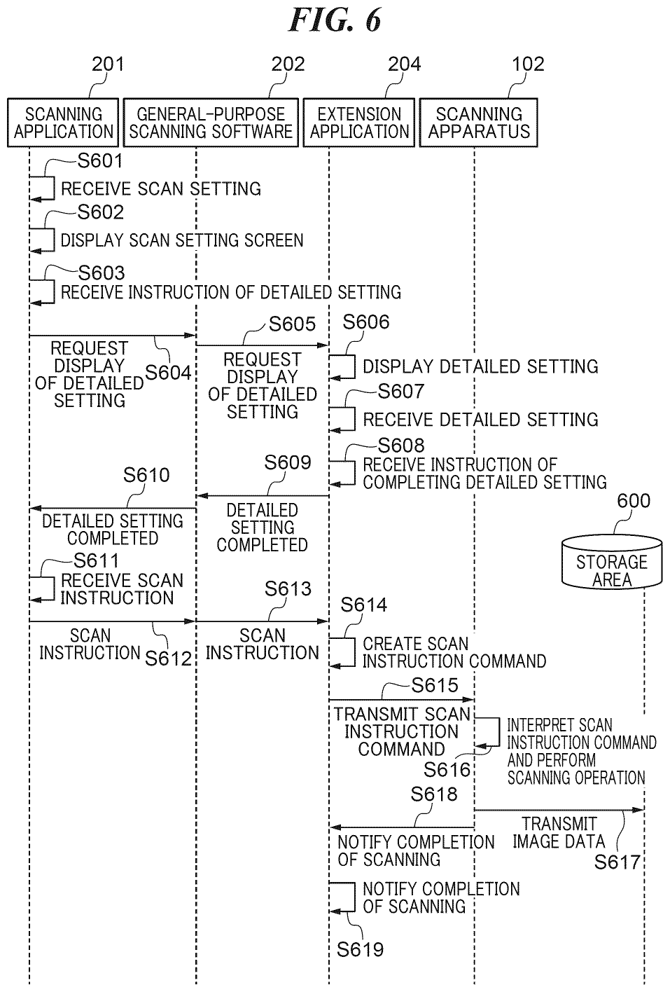

FIG. 6 is a sequence diagram showing a process to be performed between the scanning application 201, general-purpose scanning software 202, the extension application 204, and the scanning apparatus 102 after the scanning application 201 has received scan setting. The scanning application 201, the general-purpose scanning software 202, and the extension application 204 stored in the storage apparatus 114 are read by the CPU 111 from the storage apparatus 114 into the RAM 113 and executed thereby, so that the processes (steps) in the applications and software shown in the sequence diagram of FIG. 6 are realized. Some processes, such as data transmission and information input/output, are realized by the CPU 111 cooperating with various interfaces of the host computer 101. To clarify programs that serve as a main body that realizes each process shown in the sequence diagram, software units, applications, and so on will be described as subjects. The process in the scanning apparatus 102 is performed by the CPU 191 of the scanning apparatus 102. This process program is stored in the storage apparatus 199. The CPU 191 reads the process program from the storage apparatus 199 into the RAM 193 and then executes this process program. The software configuration of the scanning system 1000 corresponds to the software configuration shown in FIG. 2B.

In step S601, as shown in FIG. 6, the scanning application 201 receives scan setting from the user. The user can operate the pointing device 117 or the keyboard 118, for example, to instruct the scanning application 201 to make the scan setting.

In step S602, the scanning application 201 displays the scan setting screen 300A shown in FIG. 3A in the display part 119.

In step S603, the scanning application 201 receives an instruction as to detailed setting from the user. The user can operate the pointing device 117 or the keyboard 118, for example, to select the control 302 on the scan setting screen 300A, thereby instructing the detailed setting.

In step S604, the scanning application 201 requests the general-purpose scanning software 202 to display the detailed setting.

In step S605, the general-purpose scanning software 202 requests the extension application 204 to display the detailed setting.

In step S606, in response to the request in step S605, the scan setting screen extension unit 205 of the extension application 204 displays the detailed setting screen 300C shown in FIG. 3C in the display part 119. As described above, the scanning function extension unit 206 adds the function of setting the transmission destination of a scanned image to the scanning function information 203. The scan setting screen extension unit 205 can refer to the capability information generated based on the scanning function information 203 to which the transmission destination has been added, thereby displaying the detailed setting screen 300C.

In step S607, the scan setting screen extension unit 205 receives, from the user, the detailed setting on the detailed setting screen 300C. In this case, as an example, the “document table” is selected as the read site through the control 305 on the detailed setting screen 300C, and “C: ¥User¥123456¥Document” is inputted to the control 307 (see FIG. 3C). In this setting state, the scan setting screen extension unit 205 receives, from the user, the operation of the control 306 on the detailed setting screen 300C. In response, the CPU 111 stores the setting state on the detailed setting screen 300C, in the RAM 113.

In step S608, in response to the operation of the control 306 in step S607, the scan setting screen extension unit 205 receives an instruction of completing the detailed setting from the user. The user can operate the pointing device 117 or the keyboard 118, for example, to select the control 306, thereby giving the instruction of completing the detailed setting. The setting state on the detailed setting screen 300C is thereby written in the scanning function information 203.

In step S609, the extension application 204 transmits, to the general-purpose scanning software 202, detailed setting completion information indicating that the detailed setting has been completed in step S608.

In step S610, the general-purpose scanning software 202 receives the detailed setting completion information that has been transmitted from the extension application 204 in step S609. In response, the general-purpose scanning software 202 forwards the detailed setting completion information to the scanning application 201.

In step S611, the scanning application 201 receives a scan instruction from the user. The user can operate the pointing device 117 or the keyboard 118, for example, to select the control 303 on the scan setting screen 300A (see FIG. 3A), thereby giving the scan instruction.

In step S612, the scanning application 201 forwards the scan instruction that has been received in step S611 to the general-purpose scanning software 202.

In step S613, the general-purpose scanning software 202 receives the scan instruction that has been forwarded in step S612. In response, the general-purpose scanning software 202 forwards this scan instruction to the extension application 204.

In step S614, the extension application 204 receives the scan instruction that has been forwarded in step S613. In response, the extension application 204 creates a scan instruction command, based on the scanning function information 203 in which the setting state on the detailed setting screen 300C has been written in step S608. In this case, the scan instruction command contains setting information of the transmission destination (transmission destination “C: ¥User¥123456¥Document”) that has been received on the detailed setting screen 300C.

In step S615, the extension application 204 transmits, to the scanning apparatus 102, the scan instruction command that has been created in step S614.

In step S616, the I/O interface 198 of the scanning apparatus 102 receives the scan instruction command that has been transmitted in step S615. The reading part 195 of the scanning apparatus 102 then interprets the scan instruction command and performs a scanning operation at the read site “document table” under the setting condition that has been set through the detailed setting screen 300C. As a result, scanned image data (read image data) of the document placed on the document table is acquired. The image processing part 190 of the scanning apparatus 102 may subject this scanned image data to a necessary image process in accordance with the scan instruction.

In step S617, the I/O interface 198 of the scanning apparatus 102 transmits the scanned image data that has been acquired in step S616 to the transmission destination that has been set through the detailed setting screen 300C. The scanned image data is thereby stored in a predetermined storage area 600 at the transmission destination.

In step S618, the I/O interface 198 notifies the extension application 204 that the scanned image data has been completely transmitted.

In step S619, the extension application 204 receives the notification that the scanned image data has been completely transmitted in step S618. In response, the extension application 204 notifies the user that the scanned image data has been completely transmitted, by the notification unit 209. In this way, the user can know that the scanned image data has been completely transmitted.

As described above, the scanning system 1000 executes the setting of the transmission destination with the extension application 204, even if the general-purpose scanning software 202 does not support the function of setting a transmission destination, It is thereby possible to instruct the scanning apparatus 102 to transmit scanned image data to a desired transmission destination.

In the description given with reference to FIG. 6, the software configuration of the scanning system 1000 coincides with the software configuration shown in FIG. 2B and the detailed setting screen 300C shown in FIG. 3C is displayed in the display part 119; however, the present invention is not limited to this configuration. For example, the general-purpose scanning software 202 may display the detailed setting screen 300B shown in FIG. 3B in the display part 119 when a request for displaying the detailed setting is made to the general-purpose scanning software 202 in step S604. In this case, after the control 306 on the detailed setting screen 300B has been operated, the general-purpose scanning software 202 may request the extension application 204 to display an additional detailed setting screen. In response, the extension application 204 may display, in the display part 119, an additional detailed setting screen on which the transmission destination is settable.

The scan instruction in step S613 is given from the general-purpose scanning software 202 to the extension application 204; however, the present invention is not limited to this configuration. For example, the scan instruction may be given from the scanning application 201 to the extension application 204.

A control for a scan instruction may appear on the detailed setting screen 300C. In this case, when the user operates the control for a scan instruction, the scan instruction is given to the extension application 204. [0119] The scanning system 1000 can also transmit scanned image data to the transmission destination by the extension application 204. In addition, a storage site at which the scanned image data at the transmission destination to be stored can be set, for example, in a cloud server, a specific file application, or an external file system. In a case where a plurality of pieces of scanned image data is processed, the scanning system 1000 may transmit all the pieces of scanned image data collectively or may transmit the scanned image data one by one whenever scanned image data is acquired.

In the scanning system 1000, a notification that the transmission of scanned image data has been completed may be given, for example, by the scanning application 201 or the general-purpose scanning software 202 or may be skipped.

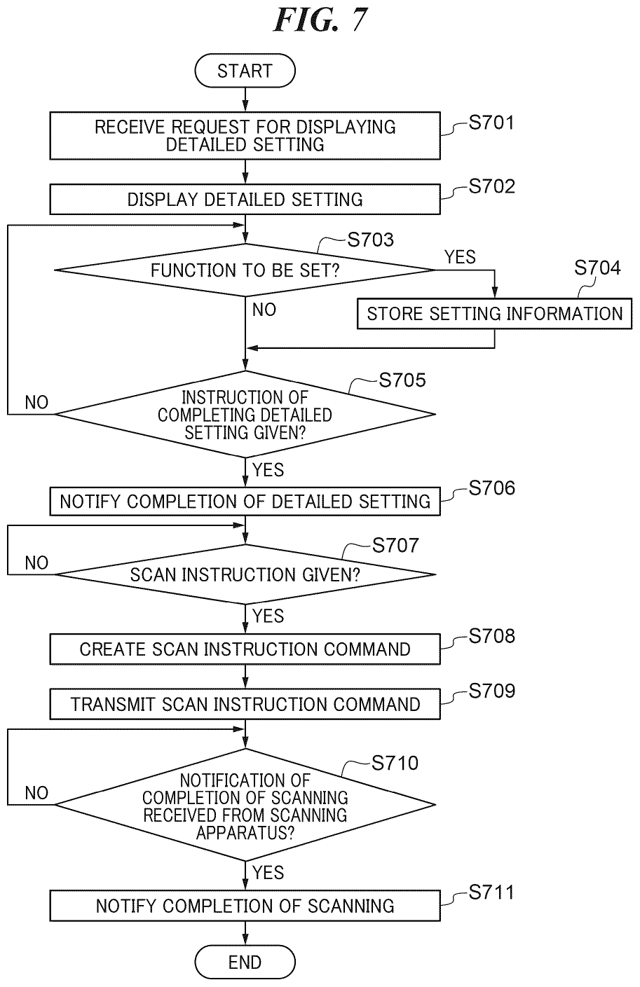

FIG. 7 is a flowchart showing a process to be performed by the extension application 204. The individual operations (steps) in the flowchart shown in FIG. 7 are realized by the CPU 111 reading a program stored in the storage apparatus 114 into the RAM 113 and performing this program. Some processes, such as data transmission and information input/output, are realized by the CPU 111 cooperating with various interfaces of the host computer 101. To clarify programs that serve as a main body that realizes each process shown in the flowchart, software units, applications, and so on will be described as subjects.

In step S701, as shown in FIG. 7, the extension application 204 receives a request for displaying the detailed setting (see step S605) from the general-purpose scanning software 202.

In step S702, the scan setting screen extension unit 205 of the extension application 204 displays the detailed setting screen 300C shown in FIG. 3C in the display part 119, in response to the request for displaying the detailed setting which has been received in step S701. As described above, the function of setting the transmission destination of a scanned image is added to the scanning function information 203. The scan setting screen extension unit 205 can refer to the capability information generated based on the scanning function information 203, thereby displaying the detailed setting screen 300C in the display part 119.

In step S703, the scan setting screen extension unit 205 determines whether the detailed setting has been made through the detailed setting screen 300C, namely, whether a selection operation has been performed on the control 305 or the control 307. As a result of the determination in step S703, when it is determined that the detailed setting has been made, the process proceeds to step S704. As a result of the determination in step S703, when it is determined that the detailed setting has not been made, the process proceeds to step S705.

In step S704, the scan setting screen extension unit 205 stores (saves), in the RAM 113, the setting state (setting information) on the detailed setting screen 300C.

In step S705, the scan setting screen extension unit 205 determines whether an instruction of completing the detailed setting has been given through the detailed setting screen 300C, namely, whether an operation has been performed on the control 306. As a result of the determination in step S705, when it is determined that the instruction of completing the detailed setting has been given, the process proceeds to step S706. As a result of the determination in step S705, when it is determined that the instruction of completing the detailed setting has not been given, the process is returned to step S703, and then the subsequent steps are sequentially performed.

In step S706, the extension application 204 notifies the general-purpose scanning software 202 that the detailed setting has been completely made in S705.

In step S707, the extension application 204 determines whether the scan instruction (see step S613) has been given from the general-purpose scanning software 202. As a result of the determination in step S707, when it is determined that the scan instruction has been given, the process proceeds to step S708. As a result of the determination in step S707, when it is determined that the scan instruction has not been given, the process stays in step S707 and enters a standby state.

In step S708, the extension application 204 creates a scan instruction command, based on the scanning function information 203 in which the setting state on the detailed setting screen 300C has been written. In this case, as described above, this scan instruction command contains setting information of the transmission destination (transmission destination “C: ¥User¥123456¥Document”) that has been received through the detailed setting screen 300C.

The method for creating the scan instruction command is, for example, a method for extending commands in a standard protocol. Furthermore, this extending method is, for example, a method of describing a dedicated command in an extended area for the commands in the standard protocol. Alternatively, the extending method is a method for adding commands of a specific standard to the end of the command in the standard protocol, a method in which the extension application 204 overwrites the commands in the standard protocol in a specific command system, and others. In addition, when the extension application 204 gives an instruction, the instruction and communication may be performed in conformity with a protocol specific to the manufacturer, independently of the standard protocol.

In step S709, the extension application 204 transmits, to the scanning apparatus 102, the scan instruction command that has been created in step S708.

In step S710, the extension application 204 determines whether a notification has been received from the scanning apparatus 102 and the notification includes information of transmission completion of the scanned image data (see step S618). As a result of the determination in step S710, when it is determined that the notification has been received, the process proceeds to step S711. As a result of the determination in step S710, when it is determined that the notification has not been received, the process stays in step S710 and enters a standby state.

In step S711, the extension application 204 notifies that the scanned image data has been completely transmitted by the notification unit 209 and then terminates the process.

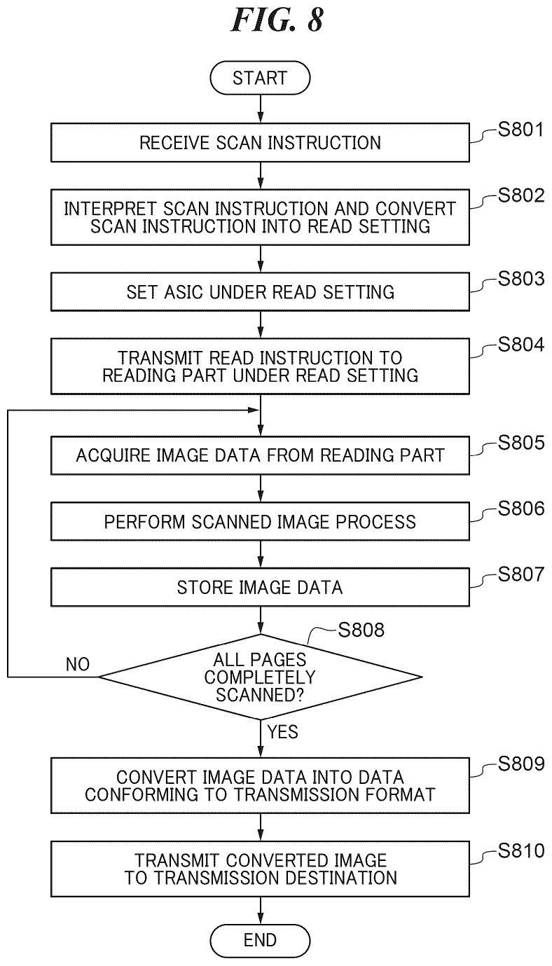

FIG. 8 is a flowchart showing a process to be performed by the scanning apparatus 102. The individual operations (steps) in the flowchart shown in FIG. 8 are realized by the CPU 191 reading a program stored in the storage apparatus 199 into the RAM 193 and performing this program. Some processes, such as data transmission and information input/output, are realized by the CPU 191 cooperating with various interfaces of the scanning apparatus 102.

In step S801, as illustrated in FIG. 8, the CPU 191 receives the scan instruction command (see step S615) from the extension application 204.

In step S802, the CPU 191 interprets the scan instruction command that has been received in step S801. The CPU 191 then converts the scan instruction command into settings (read settings) that enable the scanning apparatus 102 to perform the scanning process, namely, the scanning operation under the setting condition (read site “document table” etc.) on the detailed setting screen 300C.

In step S803, the CPU 191 determines the application-specific integrated circuit (ASIC) of the image processing part 190 to be used to perform the scanning operation and sets the ASIC, under the settings (read settings) in step S802.

In step S804, the CPU 191 transmits a read instruction to the reading part 195 under the read setting.

In step S805, the CPU 191 acquires scanned image data from the reading part 195. The scanned image data is image data acquired by reading a document placed on the document table.

In step S806, the CPU 191 controls the image processing part 190 in such a way that the image processing part 190 performs an image process on the scanned image data that has been acquired in step S805. In the present embodiment, the image process is, for example, a process of converting a resolution of the scanned image data into “300× 300 dpi”. If the reading part 195 can read the document at the resolution “300× 300 dpi”, the reading part 195 may acquire scanned image data at the resolution “300× 300 dpi”. In this case, the CPU 191 may skip step S806.

In step S807, the CPU 191 stores the scanned image data in the storage apparatus 199.

In step S808, the CPU 191 determines whether the scan process has been completely performed on all the pages of the document to be read. As a result of the determination in step S808, when it is determined that the scan process has been completely performed, the process proceeds to step S809. As a result of the determination in step S808, when it is determined that the scan process has not been completely performed, the process is returned to step S805, and then the subsequent steps are sequentially performed.

In step S809, the CPU 191 controls the image processing part 190 in such a way that the image processing part 190 converts the scanned image data that has been saved in step S807 in accordance with a transmission format. In the present embodiment, the transmission format is not contained in the scan instruction command that has been received in step S801. Thus, the scanned image data is converted into data in a joint photographic experts group (JPEG) format that is set as the default format in the scanning apparatus 102; however, the present invention is not limited to this configuration.

In step S810, the CPU 191 controls the I/O interface 198 in such a way that the I/O interface 198 transmits the image data scanned and converted in step S809 to the transmission destination and then terminates the process. The transmission destination is the setting information of the transmission destination (transmission destination “C: ¥User¥123456¥Document”) which has been received through the detailed setting screen 300C.

### Second Embodiment

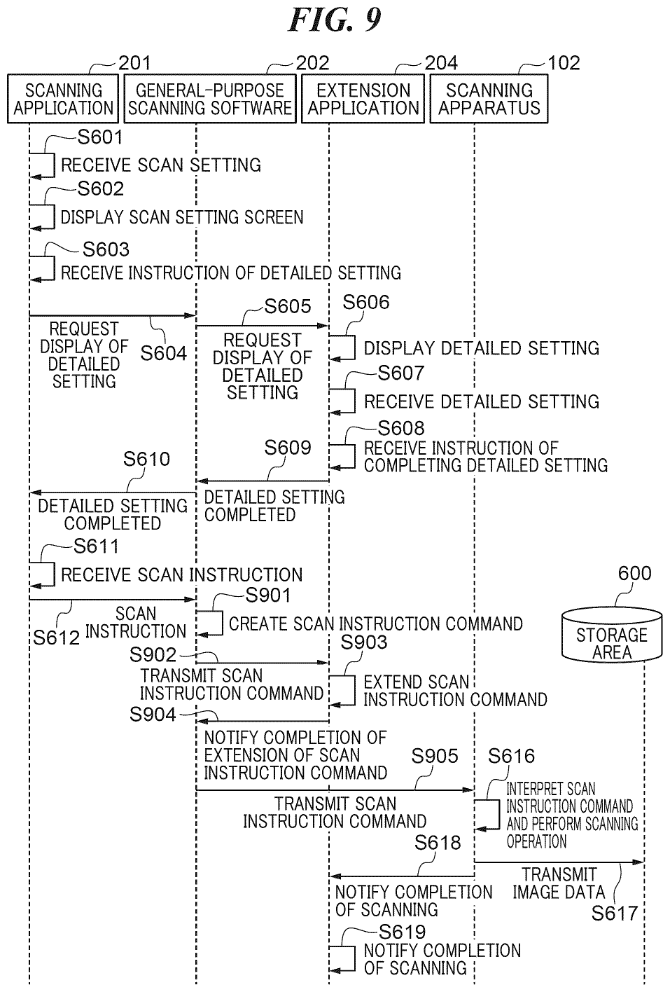

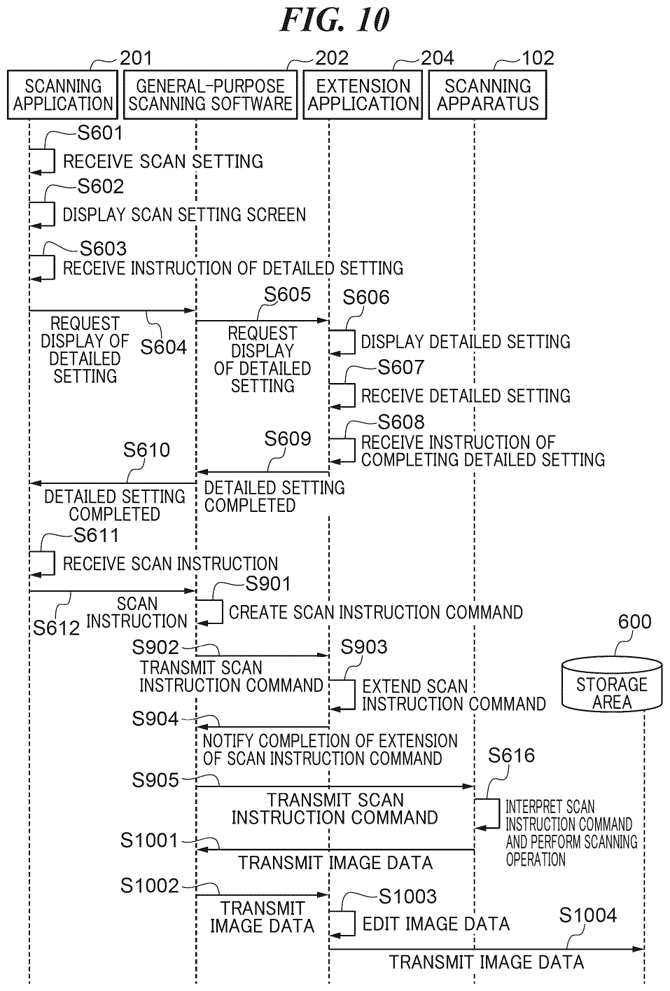

With reference to FIGS. 9 and 10, a second embodiment of the present invention will be described below. This description will focus on differences from the foregoing embodiment, and similar matters will not be described accordingly.

FIG. 9 is a sequence diagram showing a process to be performed in the second embodiment between the scanning application 201, general-purpose scanning software 202, an extension application 204, and a scanning apparatus 102 after a scanning application 201 has received a scan setting. The sequence diagram shown in FIG. 9 differs from the sequence diagram shown in FIG. 6 in that, after step S612 has been performed, steps S901 to S905 are sequentially performed instead of steps S613 to S615.

In step S901, as shown in FIG. 9, the general-purpose scanning software 202 receives the scan instruction that has been given in step S612. In response, the general-purpose scanning software 202 creates a scan instruction command, based on the scanning function information 203 in which the setting state has been written through the detailed setting screen 300C in step S608. It should be noted that this scan instruction command does not contain functions that are not supported by the general-purpose scanning software 202.

In step S902, the general-purpose scanning software 202 transmits, to the extension application 204, the scan instruction command that has been created in step S901.

In step S903, the extension application 204 receives the scan instruction that has been transmitted in step S902. The extension application 204 then adds, to the scan instruction command, an instruction command of a function that is not supported by the general-purpose scanning software 202 or changes the existing instruction. The function of the scan instruction command is thereby extended. More specifically, since the scan instruction command that has been created by the general-purpose scanning software 202 in step S901 does not contain the function of setting the transmission destination of the scanned image data, the function of setting the transmission destination is added to the scan instruction command in step S903.

In step S904, the extension application 204 notifies the general-purpose scanning software 202 that the function of the scan instruction command has been completely extended in step S903. In addition, the extension application 204 transmits the scan instruction command whose function has been extended in step S903 to the general-purpose scanning software 202.

In step S905, the general-purpose scanning software 202 receives the scan instruction that has been transmitted in step S904. In response, the general-purpose scanning software 202 transmits the scan instruction command to the scanning apparatus 102.

In the present embodiment, as described above, the scan instruction command whose function of setting the transmission destination has been extended by the extension application 204 can be transmitted to the scanning apparatus 102 by the general-purpose scanning software 202. This configuration enables the scanning apparatus 102 to transmit scanned image data to the transmission destination.

FIG. 10 is a sequence diagram showing a variation in the process to be performed in the second embodiment between the scanning application 201, the general-purpose scanning software 202, the extension application 204, and the scanning apparatus 102 after the scanning application 201 has received a scan setting. The sequence diagram shown in FIG. 10 differs from the sequence diagram shown in FIG. 9 in that, after step S616 has been performed, steps S1001 to S1004 are sequentially performed instead of steps S617 to S619.

In step S1001, as shown in FIG. 10, the I/O interface 198 of the scanning apparatus 102 transmits the scanned image data that has been acquired in step S616 to the general-purpose scanning software 202.

In step S1002, the general-purpose scanning software 202 receives the scanned image data in step S1001. In response, the general-purpose scanning software 202 forwards this scanned image data to the extension application 204. In step S1003, the extension application 204 receives the scanned image

data that has been transmitted in step S1002. The image data editing unit 207 of the extension application 204 then edits the scanned image data. This editing method is not particularly limited; however, examples thereof include an image editing method in which scanned image data is cut into an A6 size. In the present modification, as described above, for the extension application 20 performing image editing, the scanned image data that has been acquired in step S616 is received by the extension application 204 without being temporarily transmitted to the transmission destination.

In step S1004, the extension application 204 transmits the scanned image data that has been edited in step S1003 to the transmission destination that has been set through the detailed setting screen 300C. The scanned image data that has been edited in step S1003 is thereby stored in a predetermined storage area 600 at the transmission destination.

### Third Embodiment

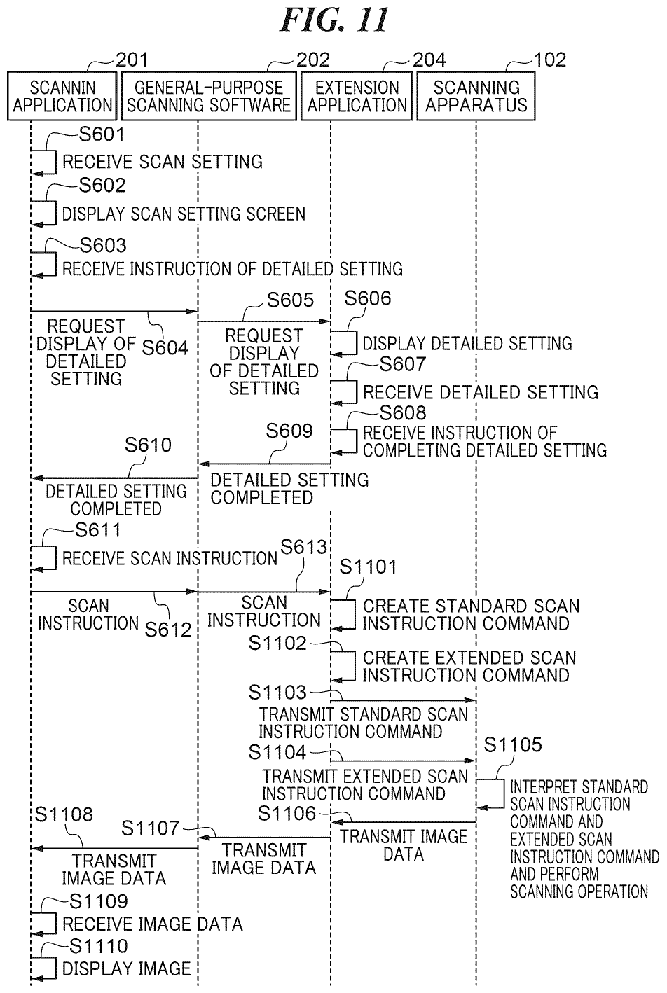

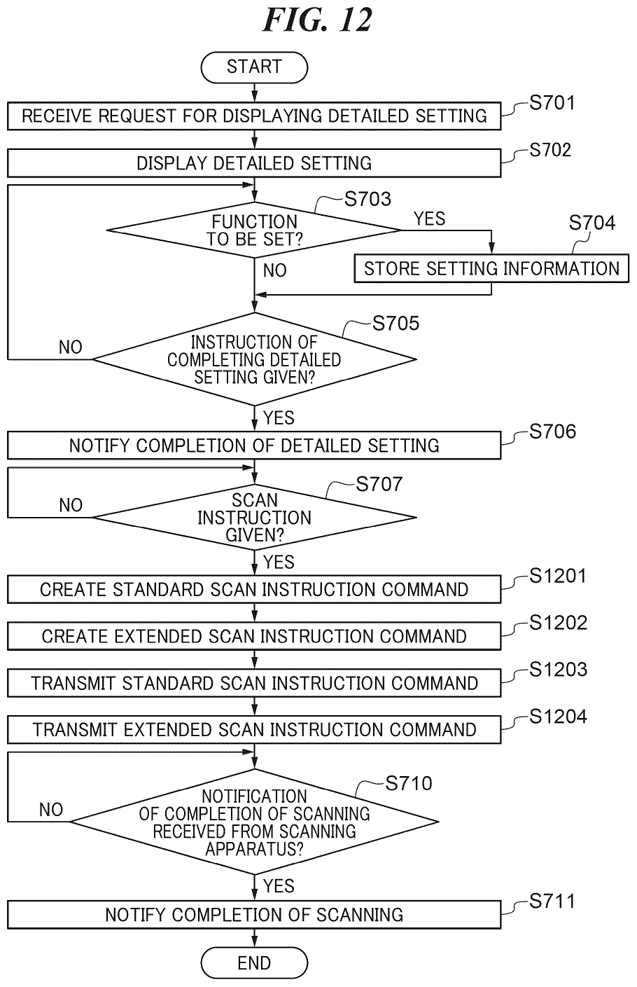

With reference to FIGS. 11 and 12, a third embodiment of the present invention will be described below. This description will focus on differences from the foregoing embodiments, and similar matters will not be described accordingly.

FIG. 11 is a sequence diagram showing a process to be performed in the third embodiment between the scanning application 201, general-purpose scanning software 202, an extension application 204, and a scanning apparatus 102 after a scanning application 201 has received a scan setting. The sequence diagram shown in FIG. 11 differs from the sequence diagram shown in FIG. 6 in that, after step S613 has been performed, steps S1101 to S1109 are sequentially performed instead of steps S614 to S619.

In step S1101, as shown in FIG. 11, the extension application 204 receives the scan instruction that has been given in step S613. The extension application 204 then creates a standard scan instruction command in conformity with a standard protocol. This standard scan instruction command does not contain functions that are not supported by the standard protocol.

In step S1102, the extension application 204 creates an extended scan instruction command regarding a function supported only by the extension application 204.

In step S1103, the extension application 204 transmits, to the scanning apparatus 102, the standard scan instruction command that has been created in step S1101.

In step S1104, the extension application 204 transmits, to the scanning apparatus 102, the extended scan instruction command that has been created in step S1102.

In step S1105, an I/O interface 198 of the scanning apparatus 102 receives both the standard scan instruction command that has been transmitted in step S1103 and the extended scan instruction command that has been transmitted in step S1104. A reading part 195 of the scanning apparatus 102 then interprets both the standard scan instruction command and the extended scan instruction command and performs a scanning operation. A scanned image data is thereby acquired.

In step S1106, the I/O interface 198 of the scanning apparatus 102 transmits the scanned image data that has been acquired in step S1105 to the extension application 204.

In step S1107, the extension application 204 receives the scanned image data that has been transmitted in step S1106. In response, the extension application 204 forwards this scanned image data to the general-purpose scanning software 202.

In step S1108, the general-purpose scanning software 202 receives the scanned image data that has been transmitted in step S1107. In response, the general-purpose scanning software 202 forwards this scanned image data to the scanning application 201.

In step S1109, the scanning application 201 receives the scanned image data that has been transmitted in step S1108.

In step S1110, the scanning application 201 displays the scanned image data that has been received in step S1109, in the display part 119. As a result, the scanned image data is displayed as a preview image in the display part 119.

FIG. 12 is a flowchart showing a process to be performed by the extension application 204. The flowchart shown in FIG. 12 differs from the flowchart shown in FIG. 7 in that steps S1201 to S1204 are sequentially performed instead of steps S707 to S709.

In step S1201, the extension application 204 creates a standard scan instruction command in conformity with a standard protocol.

In step S1202, the extension application 204 creates an extended scan instruction command regarding a function that is not supported by the standard protocol but is supported only by the extension application 204.

In step S1203, the extension application 204 transmits, to the scanning apparatus 102, the standard scan instruction command that has been created in step S1201.

In step S1204, the extension application 204 transmits, to the scanning apparatus 102, the extended scan instruction command that has been created in step S1202. After step S1204 has been performed, the process proceeds to step S710.

In the present embodiment, as described above, regarding a function that is not supported by the standard protocol, another scan instruction command can be transmitted from the extension application 204. In this way, the transmission destination can be set.

### Fourth Embodiment

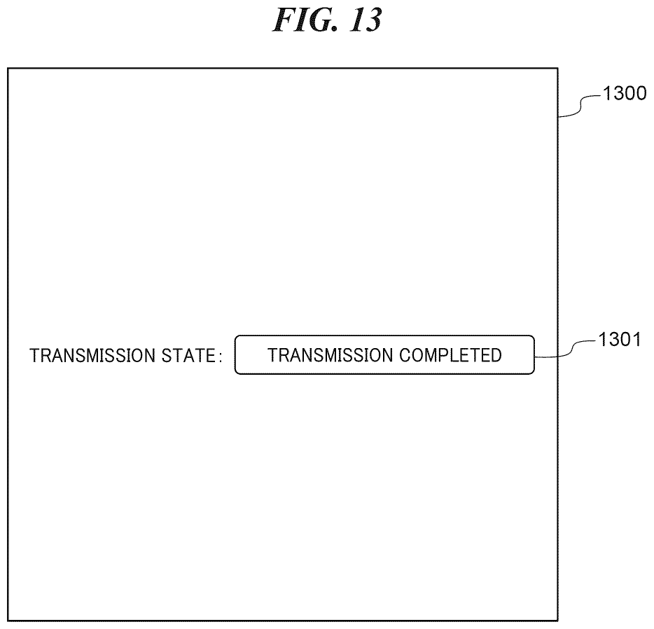

With reference to FIG. 13, a fourth embodiment of the present invention will be described below. This description will focus on differences from the foregoing embodiments, and similar matters will not be described accordingly. FIG. 13 is a view showing an example of a screen displayed in a display part 119 of a scanning system 1000 according to the fourth embodiment. A display screen 1300 shown in FIG. 13 is a screen indicating that the scanning apparatus 102 has completely transmitted scanned image data. The display screen 1300 is displayed in the display part 119 of a host computer 101 (completion display process) when the extension application 204 receives the notification that the scanned image data has been completely transmitted (see step S619) from the scanning apparatus 102. The display screen 1300 contains a message 1301 that the scanned image data has been completely transmitted. In this way, the user can know that the scanned image data has been completely transmitted.

### Fifth Embodiment

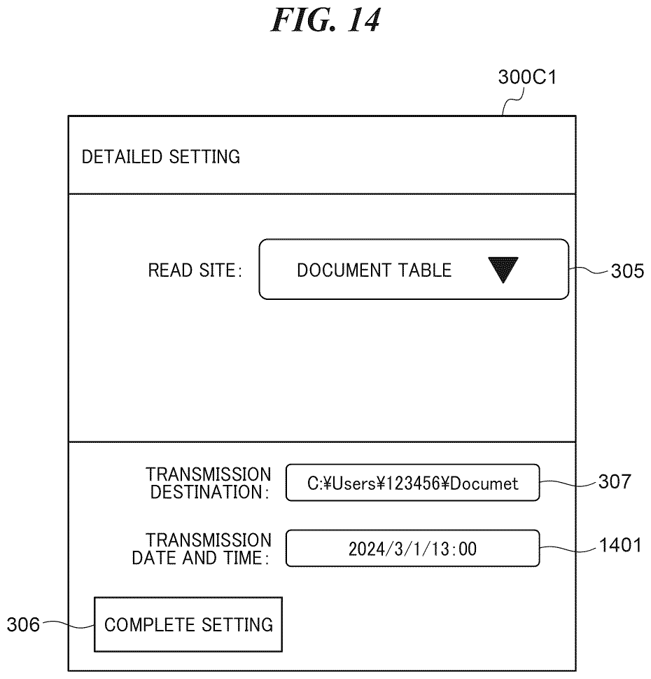

With reference to FIG. 14, a fifth embodiment of the present invention will be described below. This description will focus on differences from the foregoing embodiments, and similar matters will not be described accordingly. FIG. 14 is a view showing an example of a screen displayed in a display part 119 of a scanning system 1000 according to the fifth embodiment.

A detailed setting screen 300C1 shown in FIG. 14 contains a control 305, a control 306, a control 307, and a transmission timing input part 1401. A transmission timing of scanned image data can be input to (set through) the transmission timing input part 1401. If acquiring the scanned image data on Jan. 1, 2024, for example, the scanning apparatus 102 may transmit this scanned image data to the transmission destination on that date; however, there are cases where a user wishes to transmit the scanned image data after the passage of a given time (or day(s)). In such cases, for example, the user inputs “2024 Mar. 1/13:00” to the transmission timing input part 1401 and operates the control 306, so that this input information will be transmitted to the scanning apparatus 102. As a result, the scanning apparatus 102 will transmit the scanned image data to the transmission destination at 13:00 on Mar. 1, 2024. It should be noted that the user can operate the pointing device 117 or the keyboard 118, for example, to perform an operation of inputting the transmission timing to the transmission timing input part 1401.

### Sixth Embodiment

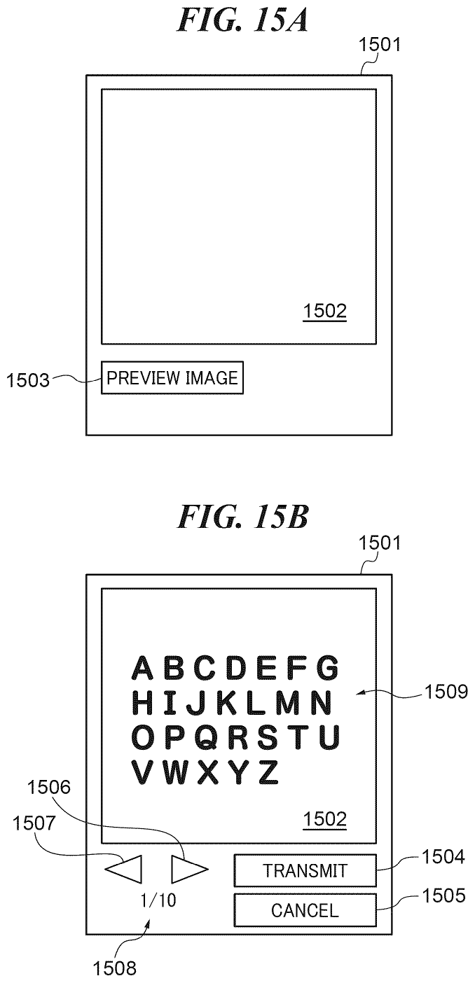

With reference to FIGS. 15A and 15B, a sixth embodiment of the present invention will be described below. This description will focus on differences from the foregoing embodiments, and similar matters will not be described accordingly. FIGS. 15A and 15B are views each showing an example of a screen displayed in a display part 119 of a scanning system 1000 according to the sixth embodiment.

FIG. 15A is a display screen 1501 on which scanned image data is displayed as a preview image. The display screen 1501 is displayed in the display part 119 of a host computer 101. The display screen 1501 contains a display area 1502 for displaying the preview image and an instruction button 1503 for instructing displaying of the preview image in the display area 1502. In response to the operation of the instruction button 1503, the display screen 1501 enters a state shown in FIG. 15B.

As shown in FIG. 15B, a preview image 1509 is displayed in the display area 1502 of the display screen 1501 (preview image display step). In addition, the display screen 1501 in the state shown in FIG. 15B contains a transmission button 1504, a cancel 1505, a forward button 1506, a rewind button 1507, and a counter 1508.

The transmission button 1504 can be used to instruct the transmission of scanned image data, which is a base of the preview image displayed in the display area 1502. The cancel 1505 can be used to cancel the transmission of the scanned image data. When the display screen 1501 is in the state shown in FIG. 15B, the user can check the preview image of the scanned image data to be transmitted which is displayed in the display area 1502 before operating the transmission button 1504. When the preview image displayed in the display area 1502 is identical to the preview image of the scanned image data to be transmitted this time, the user can operate the transmission button 1504 to transmit this scanned image data. When confirming that the preview image displayed in the display area 1502 is an image different from the preview image of the scanned image data to be transmitted this time, the user can operate the cancel 1505 to avoid the transmission of the scanned image data. Such a configuration prevents the user from transmitting wrong scanned image data.

When a plurality of preview images is present, the forward button 1506 can be used to perform a transition operation in a direction in which the images alternately appear in the forward order. In addition, when a plurality of preview images is present, the rewind button 1507 can be used to perform a transition operation in a direction in which the images alternately appear in the backward order. Moreover, when a plurality of preview images is present, the counter 1508 indicates the sequential number of the preview image currently displayed in the display area 1502.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s).

The computer may comprise one or more processors (e.g., central processing unit (CPU), micro processing unit (MPU)) and may include a network of separate computers or separate processors to read out and execute the computer executable instructions.

The computer executable instructions may be provided to the computer, for example, from a network or the storage medium.

The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments.

The scope of the following claims is to be accorded the broadest interpretation so as to encompass all such modifications and equivalent structures and functions.

When reading a document to generate scan image data, the scanning apparatus (scanner) 102 may fax this scanned image data via a modem (not shown).

If the scanning apparatus 102 is equipped with fax transmission, the detailed setting screen 300C shown in FIG. 3C may also receive the destination fax number.

Then, the extension application 204 may insert the destination number into the scan command and instruct the scanning apparatus 102 to fax the scanned image data.

In response to the reception of the fax instruction, the scanning apparatus 102 can fax the scanned image data to the destination number.

This application claims the benefit of Japanese Patent Application No. 2024-049255, filed Mar. 26, 2024, which is hereby incorporated by reference wherein in its entirety.

What is claimed is:

1. A non-transitory computer-readable storage medium storing a program which is executed by a computer and is configured for
supporting a software program that is commonly usable for a plurality of image processing apparatuses of respective manufacturers,
the program causing the computer to execute:
displaying, in a display, a setting reception screen through which setting of a transmission destination of a read image read by an image processing apparatus is received; and
causing the image processing apparatus to transmit the read image to the transmission destination that has been received through the setting reception screen.

2. The non-transitory computer-readable storage medium according to claim 1,
wherein the setting reception screen contains an input part to which the transmission destination can be input.

3. The non-transitory computer-readable storage medium according to claim 1,
wherein the setting reception screen contains a determination operating part by which the setting of the transmission destination has been completed and determined.

4. The non-transitory computer-readable storage medium according to claim 3,
wherein the program causes the computer to execute making the transmission when the determination operating part is operated.

5. The non-transitory computer-readable storage medium according to claim 1,
wherein through the setting reception screen, setting of a transmission timing of the read image is received upon the transmission.

6. The non-transitory computer-readable storage medium according to claim 5,
wherein the setting reception screen contains a transmission timing input part to which the transmission timing can be input.

7. The non-transitory computer-readable storage medium according to claim 1,
wherein the program causes the computer to execute switching whether to display the setting reception screen, depending on the image processing apparatus.

8. The non-transitory computer-readable storage medium according to claim 1,
wherein the program causes the computer to execute displaying, in the display, a notification that the transmission of the read image has been completed.

9. The non-transitory computer-readable storage medium according to claim 1,
wherein the program causes the computer to execute displaying a preview image of the read image in the display.

10. A control method for controlling support of a software program that is commonly usable for a plurality of image processing apparatuses of respective manufacturers, the control method comprising:
displaying, in a display, a setting reception screen through which setting of a transmission destination of a read image read by the image processing apparatus is received; and
causing the image processing apparatus to transmit the read image to the transmission destination that has been received through the setting reception screen.

11. An information processing apparatus that can be connected to a plurality of image processing apparatuses of respective manufacturers to enable communication and that can process information with each of the image processing apparatuses, comprising:
a processor; and
one or more memories storing
a software program that is commonly usable for the image processing apparatuses of the respective manufacturers, and
an application program supporting the software program which, when executed by the processor, causes the information processing apparatus to:
display, in a display, a setting reception screen through which setting of a transmission destination of a read image read by the image processing apparatus is received; and
cause the image processing apparatus to transmit the read image to the transmission destination that has been received through the setting reception screen.
